(19) United States
(12) Patent Application Publication
(10) Pub. No.: US 2026/0106868 A1
(43) Pub. Date: Apr. 16, 2026

(54) SYSTEMS AND METHODS FOR REAL-TIME TELEMETRY-BASED DETECTION OF IMPERSONATION IN INTERACTIVE DIALOGUE APPLICATIONS

(71) Applicant: BANK OF AMERICA CORPORATION, CHARLOTTE, NC (US)

(72) Inventors: Nagasubramanya Lakshminarayana, Concord, NC (US); Vijay Kumar Yarabolu, Hyderabad (IN)

(73) Assignee: BANK OF AMERICA CORPORATION, CHARLOTTE, NC (US)

(21) Appl. No.: 18/914,867

(22) Filed: Oct. 14, 2024

(51) Int. Cl. H04L 9/40

(52) U.S. Cl. CPC H04L 63/0861; H04L 63/0838; H04L 63/18

(57) ABSTRACT

Systems, computer program products, and methods are described herein for real-time telemetry-based detection of impersonation in interactive dialogue applications. The system includes a processing device and a non-transitory storage device containing instructions which, when executed, cause the processing device to initiate an interactive chat session, authenticate the user, and establish a secure session. The system collects and monitors telemetry data from the user's device, including CPU usage, memory consumption, network traffic, and other metrics. The telemetry data is analyzed in real-time to identify abnormal patterns indicative of impersonation. If suspicious activity is detected, the system triggers an Out-of-Band Authentication (OoBA) process, requiring the user to verify their identity via a secondary communication channel. If the OoBA fails or telemetry anomalies persist, the system terminates the session and flags the device for further investigation. This solution provides enhanced security without disrupting the user experience.

### TECHNOLOGICAL FIELD

Example embodiments of the present disclosure relate to real-time telemetry-based detection of impersonation in interactive dialogue applications.

### BACKGROUND

Chatbots have become increasingly integral to various industries, particularly with advancements in Large Language Models (LLMs) such as ChatGPT, Llama, and Gemini. These models have enabled chatbots to provide more advanced and complex services, including offering financial advice and assisting with investment decisions. However, as chatbot usage increases, so does the issue of malfeasance. A notable threat is the user impersonation attack, where malicious actors utilize vulnerabilities in chatbot systems to masquerade as legitimate users. Such attacks can leverage sophisticated tools, including password spraying, to initiate automated conversations aimed at extracting sensitive information. Once a session is established, it can be challenging to differentiate between an authentic user and an imposter, as traditional security measures like OTPs or additional authentication can disrupt the user experience and are often avoided during chat sessions.

Applicant has identified a number of deficiencies and problems associated with real-time telemetry-based detection of impersonation in interactive dialogue applications. Through applied effort, ingenuity, and innovation, many of these identified problems have been solved by developing solutions that are included in embodiments of the present disclosure, many examples of which are described in detail herein

### BRIEF SUMMARY

Systems, methods, and computer program products are provided for real-time telemetry-based detection of impersonation in interactive dialogue applications.

The disclosed systems analyze telemetry data from the client device during active chat sessions, including power consumption, memory usage, CPU utilization, and network activity. This telemetry data is continuously monitored and analyzed to detect patterns indicative of user impersonation attacks. When anomalies or abnormal behaviors are identified, such as disproportionate CPU usage or unexpected network activity in relation to the ongoing chat session, further validation processes are initiated. These processes may involve confirming the legitimacy of the user's device through authentication of its source or triggering out-of-band verification, such as sending an authorization code to the user's mobile device. If the data points align with suspected impersonation activity, the system can terminate the chat session and block future requests from the flagged device, thus providing an additional layer of security without compromising the user experience.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for real-time telemetry-based detection of impersonation in interactive dialogue applications, in accordance with an embodiment of the disclosure;

FIG. 2 illustrates an exemplary generative AI subsystem %00, in accordance with an embodiment of the invention; and

FIG. 3 illustrates a process flow 300 for real-time telemetry-based detection of impersonation in interactive dialogue applications, in accordance with an embodiment of the disclosure; and

FIG. 4 illustrates a process flow 400 for real-time telemetry-based detection of impersonation in interactive dialogue applications, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “Telemetry Data” refers to real-time, device-generated data that provides information about the operational status and resource usage of a client device. This data may include, but is not limited to, power consumption, memory usage, CPU utilization, network traffic, disk activity, device state, fan speed, and active processes running on the client device. Telemetry data may be used to monitor the performance of the device during a user session and identify patterns of activity. In the context of the present disclosure, telemetry data is specifically employed to detect anomalies or abnormal behaviors that could indicate a user impersonation attack or other security issues. Telemetry data may be continuously collected, aggregated, and analyzed in real time, and may be compared to baseline values or expected patterns to flag deviations that suggest potential malicious activity. Telemetry data is essential in maintaining the integrity of an interactive dialogue session without requiring additional input from the user.

As used herein, “Impersonation Attack” refers to a malicious activity in which an unauthorized entity or individual attempts to falsely represent themselves as a legitimate user in an interactive dialogue session, such as a chatbot conversation, for the purpose of extracting sensitive information, performing unauthorized actions, or compromising system security. Impersonation attacks may be carried out through various methods, including credential malfeasance, brute-force password guessing, session hijacking, or utilization of authentication vulnerabilities. In some instances, attackers may leverage automated tools to launch large-scale impersonation attacks, utilizing tactics such as password spraying or utilizing weak authentication mechanisms. The goal of such attacks is typically to gain access to sensitive data or carry out actions that would otherwise be restricted to legitimate users. In the context of the present disclosure, impersonation attacks are detected by monitoring telemetry data for unusual activity or behavior that deviates from normal user patterns.

As used herein, “Interactive Dialogue Application” refers to any computer-based system or software that facilitates real-time interaction between a user and a machine through text, voice, or other input methods. Examples of interactive dialogue applications include, but are not limited to, chatbots, virtual assistants, and conversational AI systems. These applications use various input and output devices, such as keyboards, microphones, speakers, or graphical user interfaces (GUIs), to engage in two-way communication with a user. The interactive nature of such applications allows users to perform tasks, retrieve information, or execute commands based on the responses generated by the system. Interactive dialogue applications may be deployed across various platforms, including web-based services, mobile applications, or integrated software in hardware devices. In the present disclosure, interactive dialogue applications serve as the environment where user impersonation attacks may occur, and telemetry data is collected and analyzed during these sessions to enhance security.

As used herein, “User Authentication” refers to the process by which the identity of a user interacting with a system is verified to ensure that the user is legitimate and authorized to access the system's resources or perform certain actions. User authentication may involve a variety of methods, including but not limited to, the use of credentials such as usernames and passwords, biometric verification (e.g., fingerprint or facial recognition), or multi-factor authentication, which requires users to provide more than one form of identity verification (e.g., password and a one-time passcode sent to a mobile device). In the context of the present disclosure, user authentication is a critical security mechanism that occurs at the start of and throughout an interactive dialogue session to prevent unauthorized access. Authentication processes may be enhanced by leveraging telemetry data to detect abnormal behavior, and in the case of suspicious activity, secondary authentication methods such as Out-of-Band Authentication (OoBA) may be triggered to further verify the user's identity.

As used herein, “Out-of-Band Authentication (OoBA)” refers to a security mechanism that validates a user's identity through a separate communication channel that is distinct from the primary communication session. OoBA is typically used as an additional layer of security to verify the legitimacy of a user when abnormal or suspicious activity is detected during a session. For example, in the event that an anomaly is detected in the telemetry data during an interactive dialogue session, an OoBA process may be initiated by sending a unique verification code to the user's mobile device or email address, which the user must input into the system to confirm their identity. This separate communication channel helps mitigate the issue of impersonation attacks, as an attacker would need access to both the primary session and the secondary communication method to successfully authenticate. OoBA methods may include SMS-based passcodes, email verification links, phone calls, or biometric verification conducted through a separate trusted device.

As used herein, “Suspicious Activity” refers to any behavior, process, or data pattern that deviates from normal operational characteristics of a user or client device during an interactive dialogue session. Suspicious activity may include, but is not limited to, abnormal spikes in CPU or memory usage, unusual network traffic patterns, deviations from standard power consumption, or unexpected software processes running in the background. In the context of this disclosure, suspicious activity is identified through the continuous monitoring of telemetry data from the client device and is often indicative of potential security threats, such as impersonation attacks or unauthorized access attempts. When suspicious activity is detected, further verification methods, such as Out-of-Band Authentication (OoBA), may be initiated to ensure the legitimacy of the session.

As used herein, “Telemetry Monitoring Engine” refers to the software, hardware, or combination of both that is responsible for collecting, analyzing, and processing telemetry data from client devices in real time. The telemetry monitoring engine continuously gathers data such as CPU utilization, memory usage, network activity, and power consumption to detect patterns or anomalies that may signal unauthorized access or suspicious behavior. The engine may employ machine learning algorithms, statistical models, or heuristic methods to assess the data and determine whether the session is operating within normal parameters. In the event that the telemetry monitoring engine identifies behavior indicative of an impersonation attack or other security issues, it can initiate protective actions, such as terminating the session or triggering Out-of-Band Authentication (OoBA).

As used herein, “Generative AI Subsystem” refers to a computational system that employs artificial intelligence (AI) models, particularly generative models, to analyze telemetry data, generate patterns, or predict potential security threats in real-time. The generative AI subsystem may include components for data ingestion, pre-processing, model training, and anomaly detection. These components work together to identify suspicious behaviors or anomalies by comparing real-time telemetry data with established patterns of normal activity. The AI models within the subsystem, such as Variational Autoencoders (VAEs) or Generative Adversarial Networks (GANs), are trained on large datasets to recognize subtle deviations that might otherwise be missed by conventional monitoring techniques. In the context of the present disclosure, the generative AI subsystem plays a critical role in enhancing the accuracy of impersonation attack detection, minimizing false positives, and improving the overall security of interactive dialogue applications.

As used herein, “Anomaly Detection” refers to the process of identifying data points, behaviors, or system processes that deviate significantly from established baselines or expected patterns of normal operation. Anomalies may include, but are not limited to, spikes in CPU usage, unusual memory consumption, unexpected network traffic, or other deviations in telemetry data that suggest abnormal or unauthorized activity. In the context of this disclosure, anomaly detection is critical for identifying impersonation attacks or other security breaches in real-time interactive dialogue sessions. The anomaly detection process may be carried out by the telemetry monitoring engine, which continuously evaluates telemetry data against predefined thresholds or dynamic machine learning models. When an anomaly is detected, it triggers protective measures such as Out-of-Band Authentication (OoBA) or session termination to mitigate potential threats.

As used herein, “Authentication Credentials” refers to the information or data used to verify the identity of a user attempting to access a system, service, or interactive dialogue application. Authentication credentials may include, but are not limited to, usernames, passwords, personal identification numbers (PINs), biometric data (such as fingerprints, facial recognition, or voice patterns), or cryptographic tokens. These credentials are typically provided by the user during the authentication process to prove their identity and gain access to protected resources or services. In some cases, authentication credentials may be combined in multi-factor authentication (MFA) to increase security, requiring the user to provide more than one type of credential (e.g., a password and a one-time passcode sent to a mobile device). In the present disclosure, authentication credentials are validated during the initiation and throughout the duration of an interactive session, with additional verification measures, such as Out-of-Band Authentication (OoBA), being triggered if telemetry data indicates suspicious or abnormal behavior.

As used herein, “Bot Interaction Timeline” refers to the sequence of events, exchanges, or interactions between a user and an interactive dialogue application, such as a chatbot, over a defined period of time during a session. The bot interaction timeline includes data related to when the session is initiated, the duration of user engagement, the specific commands or inputs provided by the user, and the corresponding outputs or responses generated by the chatbot. In the context of this disclosure, the bot interaction timeline is analyzed in conjunction with telemetry data to detect unusual patterns of behavior that may indicate an impersonation attack. For instance, correlated spikes in system resource usage during certain phases of the interaction timeline may serve as markers for identifying suspicious activity. The bot interaction timeline is a critical component in understanding the flow of communication and in determining if anomalies within the session correspond to possible security threats.

As used herein, “Device Fingerprinting” refers to the process of identifying and characterizing a client device based on the unique combination of its hardware and software attributes, as well as telemetry data generated during operation. Device fingerprinting may include, but is not limited to, data points such as operating system details, browser type and version, installed applications, CPU and memory configurations, power usage, network activity, and system state. These characteristics form a unique digital fingerprint that can be used to verify the identity of the device and detect any changes or anomalies over time. In the context of this disclosure, device fingerprinting is used to enhance security by continuously monitoring the client device for deviations from its known fingerprint, which may indicate unauthorized access, impersonation attacks, or device tampering. When suspicious deviations are detected, further authentication or protective actions, such as terminating the session, may be triggered.

As used herein, “Active Processes” refers to the set of tasks, operations, or applications that are currently running on a client device during an interactive session with an interactive dialogue application. These processes may include system-level operations, user-initiated applications, or background services that are necessary for the device's operation. Active processes may be monitored in real time to assess the behavior of the device and detect any unusual or unauthorized processes that may indicate a security threat. In the context of this disclosure, the system continuously tracks active processes to identify patterns or activities that deviate from normal operation. Any new or unusual processes, particularly those using disproportionate CPU or memory resources, may trigger further investigation or security measures, such as Out-of-Band Authentication (OoBA) or session termination, to ensure that an impersonation attack is not in progress.

As used herein, “Out-of-Band Verification (OoBV)” refers to the process of verifying a user's identity using a separate, trusted communication channel, distinct from the primary interactive session. This method is typically triggered when suspicious activity is detected during an active session, and it provides an additional layer of security to confirm the user's authenticity. For example, if telemetry data indicates a potential impersonation attack, the system may send a verification code to the user's registered mobile device or email. The user must then enter the code in the primary session to confirm their identity. By using a separate channel, OoBV mitigates the issue of an attacker compromising both the primary session and the verification channel. OoBV methods may include SMS-based codes, email links, or other forms of verification through trusted devices or applications.

As used herein, “Session Termination” refers to the process of ending or forcibly closing an active interactive session between a user and an interactive dialogue application, typically in response to the detection of suspicious activity or security threats. Session termination may be initiated by the system when telemetry data indicates anomalies such as unusual resource usage, unauthorized processes, or deviations from normal user behavior. Upon termination, the system may log the event, flag the client device or user account for further review, and block future access attempts from the same device or session origin. In the context of this disclosure, session termination serves as a critical security measure to prevent ongoing impersonation attacks or unauthorized access, protecting the integrity of the user session and the system. The terminated session may also be quarantined for further investigation to assess the nature of the threat.

As used herein, “Heuristic-Based Detection” refers to the process of identifying suspicious or abnormal behavior within a system based on predefined rules, algorithms, or patterns derived from prior knowledge or experience. In this context, heuristic-based detection utilizes specific thresholds, anomaly patterns, or known behaviors associated with impersonation attacks to flag potential security threats. This method does not rely solely on static signature-based detection but instead uses approximations or educated guesses to identify new or unknown threats. For example, excessive CPU or memory usage during an interactive session may trigger heuristic rules that indicate a potential impersonation attack. The advantage of heuristic-based detection lies in its ability to catch sophisticated or evolving threats that may not have been previously documented. The system may also employ machine learning models to continuously update these heuristics based on new data inputs and telemetry patterns.

As used herein, “Telemetry Heatmap” refers to a visual or graphical representation of telemetry data, showing the activity and resource usage of various processes or components of a client device over time. Each axis of the heatmap typically corresponds to different telemetry attributes, such as CPU usage, memory consumption, network traffic, or power usage, while the intensity of color or shading represents the degree of resource usage or deviation from the baseline. In the context of this disclosure, telemetry heatmaps are used to observe patterns, spikes, or anomalies in the telemetry data during an interactive session. For example, a sudden spike in network activity or CPU load that coincides with a bot interaction might be flagged as suspicious. Heatmaps allow for an intuitive, high-level overview of how the device's resources are being utilized and help identify outliers or irregular processes that may indicate impersonation attempts or unauthorized access.

As used herein, “Correlated Spike” refers to a significant increase in device resource usage (such as CPU, memory, or network traffic) that occurs in conjunction with a particular event, such as a bot interaction or user input. In this context, a correlated spike is used as an indicator of potential suspicious activity, particularly when the spike occurs outside of normal operational parameters or expected system behavior. For instance, if a bot interaction triggers an unusual spike in memory consumption or network traffic, this might suggest that unauthorized processes are running in the background or that an impersonation attack is underway. The system continuously monitors for such correlated spikes and may use them as triggers for further investigation or to initiate additional security measures, such as Out-of-Band Authentication (OoBA) or session termination.

As used herein, “Authenticated Device” refers to a client device that has been verified as legitimate and authorized to access a system or service based on its telemetry data and metadata. Device authentication may be established through a combination of factors, including the device's hardware characteristics, software environment, operating system version, and historical telemetry data patterns. The device's installation source, vendor credibility, and usage history may also be considered during authentication. Once a device is authenticated, it is granted access to the system, and its interactions are monitored for any deviations from the established baseline. In the context of this disclosure, if a device shows signs of suspicious activity after authentication (e.g., abnormal telemetry data or correlation spikes), additional verification processes, such as Out-of-Band Authentication (OoBA), may be triggered to confirm the legitimacy of the session.

As used herein, “Client Device” refers to any electronic device that a user employs to interact with an interactive dialogue application or system. Client devices may include, but are not limited to, personal computers, laptops, smartphones, tablets, or any other Internet-connected hardware that can initiate and maintain a session with the server-side application. Each client device generates telemetry data, which may be continuously monitored and analyzed to detect suspicious activity or unauthorized access. In the context of this disclosure, the client device is a critical component in real-time security monitoring, with its telemetry data being used to identify impersonation attacks or other threats during a live session. A client device's unique characteristics, such as hardware specifications, operating system, and active processes, contribute to its fingerprint, which is used to authenticate and verify its interactions with the system.

As used herein, “Flagged Device” refers to a client device that has been identified as potentially compromised or involved in suspicious activity based on an analysis of its telemetry data. A device may be flagged if it exhibits behaviors outside of established baselines, such as abnormal spikes in resource usage, unauthorized processes, or deviations in network traffic. Once flagged, the device may be subject to additional scrutiny, such as Out-of-Band Authentication (OoBA) or session termination, to mitigate the issue of an impersonation attack or other malicious activity. Flagged devices may also be temporarily or permanently blocked from accessing the system until further validation or investigation has been completed. In the context of the present disclosure, flagging a device serves as a proactive measure to protect the integrity of interactive dialogue applications and user sessions.

As used herein, “Outlier Process” refers to any process running on a client device that significantly deviates from normal operational parameters in terms of resource usage, behavior, or telemetry patterns. Outlier processes are typically identified by comparing real-time telemetry data against baseline data or expected patterns of activity. Such processes may consume an unusually high amount of CPU, memory, or network resources, or may originate from unauthorized or unverified sources. In the context of this disclosure, outlier processes are flagged for further investigation as they may indicate the presence of malware, unauthorized software, or impersonation attacks. When outlier processes are detected, the system may trigger protective measures such as session termination or additional verification procedures.

As used herein, “Session Persistence” refers to the continuity and duration of an active user session with an interactive dialogue application, particularly as it relates to maintaining security and preventing unauthorized access throughout the session. In the context of this disclosure, session persistence is closely monitored through telemetry data to ensure that no security breaches occur while the session remains active. If suspicious activity is detected during a persistent session—such as an anomaly in resource usage or an unauthorized process—the system may initiate protective actions, such as Out-of-Band Verification (OoBV) or session termination, to mitigate the threat. Session persistence ensures that security is enforced throughout the entire lifecycle of the session, rather than just at the initial authentication point.

As used herein, “Device Source Validation” refers to the process of verifying the origin and legitimacy of a client device based on its telemetry data, installation metadata, and other identifying characteristics. This process may include validating the device's hardware components, operating system, vendor credibility, and the source of any installed software or applications. In the context of this disclosure, device source validation is used to ensure that the device interacting with the system is authentic and has not been compromised or tampered with. The system may continuously perform device source validation during an interactive session, and if discrepancies are detected—such as mismatches in device metadata or abnormal telemetry data—further security measures, such as Out-of-Band Authentication (OoBA), may be initiated. Device source validation is critical in preventing impersonation attacks and maintaining the integrity of the session.

As used herein, “Telemetry Snapshot” refers to a captured instance of telemetry data from a client device at a specific point in time during an interactive session. This snapshot includes real-time data points such as CPU usage, memory consumption, network traffic, disk activity, and other resource utilization metrics. Telemetry snapshots are used to provide a granular view of device behavior and resource usage at a given moment, enabling the system to detect anomalies or unusual activity that could indicate a security breach. In the context of this disclosure, telemetry snapshots are compared against historical baseline data or analyzed for deviations that suggest an impersonation attack. If significant deviations are detected within the snapshot, further actions such as session termination or additional verification steps may be triggered.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

The present technology relates to systems and methods for real-time detection of user impersonation attacks in interactive dialogue applications, such as chatbots, which leverage real-time telemetry data from client devices to identify suspicious activities. The technology enhances the security and integrity of chatbot systems, preventing unauthorized access while maintaining a seamless user experience.

In the field of interactive dialogue applications, such as chatbots, a significant problem arises from the increasing sophistication of impersonation attacks. Malicious actors utilize vulnerabilities in authentication mechanisms to impersonate legitimate users and gain access to sensitive information. Traditional security measures, such as multi-factor authentication or additional verification steps, are often too cumbersome during live chat sessions, leading to reduced user satisfaction or incomplete security enforcement. This makes it challenging to detect when a user is being impersonated, particularly in real time, without disrupting the flow of conversation or requiring intrusive measures.

The present solution solves this problem by continuously monitoring telemetry data from the client device during active chat sessions. This data, including information such as power consumption, CPU usage, memory utilization, and network activity, is analyzed in real time to detect anomalies indicative of impersonation attempts. If suspicious behavior is identified, further verification can be initiated, such as out-of-band authentication or device source validation. This approach minimizes disruption to legitimate users while providing an effective barrier against impersonators, thus maintaining the integrity of the chat session without introducing unnecessary friction into the process.

Accordingly, the present disclosure provides a system and method for real-time telemetry-based detection of user impersonation in interactive dialogue applications. This is achieved by continuously monitoring and analyzing telemetry data from client devices to detect patterns indicative of malicious activity. Upon detecting anomalies, the system can initiate out-of-band verification processes, terminate suspicious sessions, and block future requests from flagged devices. This solution offers an enhanced layer of security without compromising the user experience, and it addresses the growing threat of sophisticated impersonation attacks in chat-based environments.

What is more, the present disclosure provides a technical solution to a technical problem. As described herein, the technical problem includes the detection of user impersonation attacks in real-time chat sessions without disrupting the user experience. The technical solution presented herein allows for real-time monitoring of telemetry data from the client device to detect abnormal behavior or patterns that suggest an impersonation attack. In particular, the solution continuously analyzes telemetry data, such as CPU usage, memory consumption, and network activity, to identify suspicious activity in a non-intrusive manner. This approach is an improvement over existing solutions to the problem of detecting impersonation attacks, as it: (i) reduces the number of steps required to identify impersonation, thus conserving computing resources such as processing power and storage; (ii) provides a more accurate detection method, reducing the need for costly error correction; (iii) minimizes manual input by automating the detection process, improving the speed and efficiency of the solution; (iv) determines an optimal amount of computing resources required to identify impersonation attacks, reducing network traffic and the overall load on computing infrastructure. Furthermore, the technical solution described herein leverages a rigorous, computerized process that automates detection and response to user impersonation in chat sessions, tasks that were previously performed manually or required excessive resources. In specific implementations, this solution bypasses several steps involved in traditional verification processes, thereby further conserving computing resources and optimizing performance.

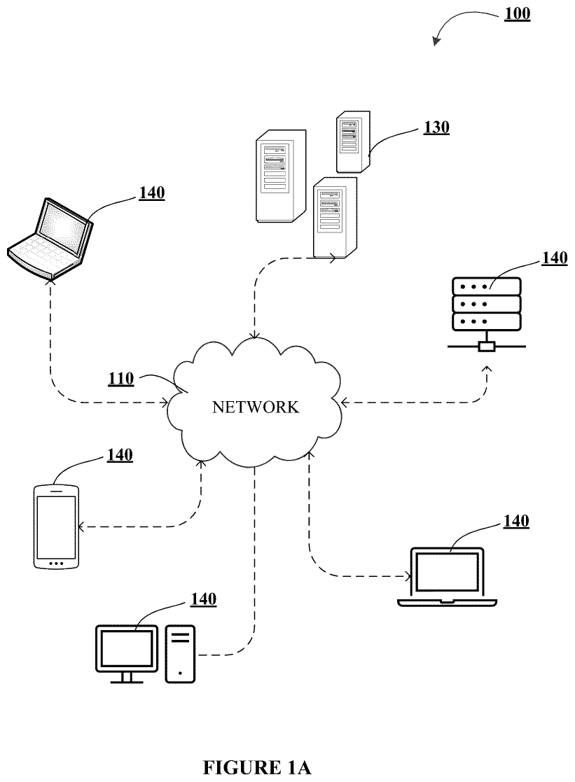

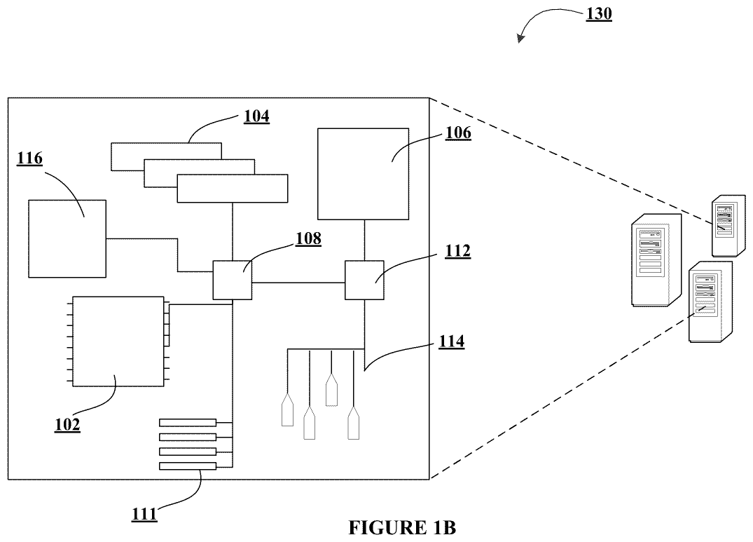

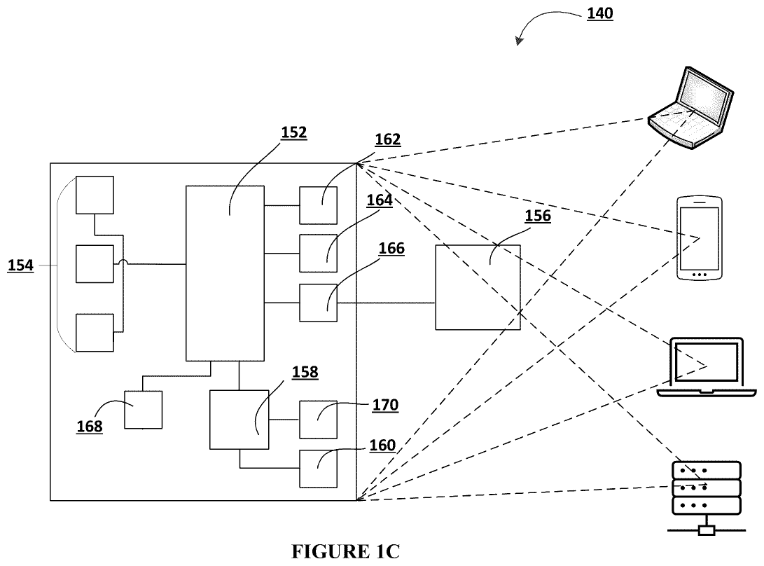

FIGS. 1A-1C illustrate technical components of an exemplary distributed computing environment for real-time telemetry-based detection of impersonation in interactive dialogue applications 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

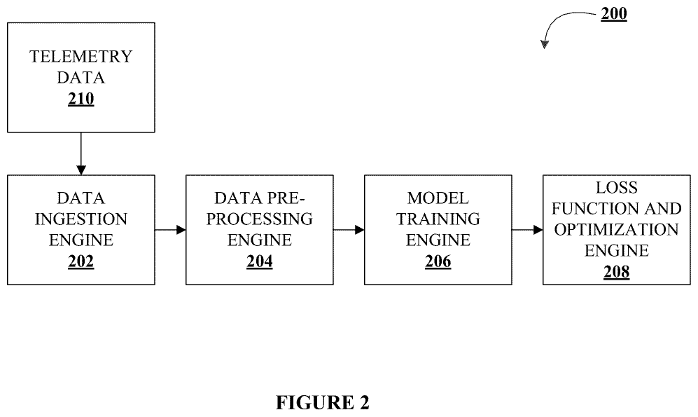

FIG. 2 illustrates an exemplary generative AI subsystem 200, in accordance with an embodiment of the invention. The generative AI subsystem 200 may include a data ingestion engine 202, a data pre-processing engine 204, a model training engine 206, and a loss function and optimization engine 208. It should be understood that the generative AI subsystem 200 is merely an example, and other embodiments may include more, fewer, or different components depending on the specific requirements and implementations of the system. For instance, additional engines for data validation, feature selection, or distributed computing may be integrated into the subsystem, or certain components described herein may be consolidated or omitted based on system performance objectives. Therefore, the generative AI subsystem 200 should not be considered limiting and may be adapted to various configurations within the scope of the invention.

The data ingestion engine 202 may identify various internal and/or external data sources to generate, test, and/or integrate new features for training the generative AI model. These internal and/or external data sources may be initial locations where the data originates or where physical information is first digitized. In addition to conventional data sources, the data ingestion engine 202 may support decentralized storage systems, such as blockchain-based data sources, and privacy-preserving methods such as differential privacy. The data ingestion engine 202 may identify the location of the data and describe connection characteristics for access and retrieval of data. In some embodiments, data is transported from each data source using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like.

Depending on the nature of the data, the data ingestion engine 202 may move the data to a destination for storage or further analysis. Typically, the data may be in varying formats as they come from different sources, including RDBMS, other types of databases, S3 buckets, CSVs, or from streams. Since the data comes from different places, it needs to be cleansed and transformed so that it can be analyzed together with data from other sources. The data may be ingested in real-time, using stream processing, in batches using a batch data warehouse, or a combination of both. Stream processing may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse collects and transfers data in batches according to scheduled intervals, trigger events, or any other logical ordering.

In machine learning, the quality of data and the useful information that can be derived therefrom directly affects the ability of the machine learning model to learn. The data pre-processing engine 204 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed. In some embodiments, the data pre-processing engine 204 may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine 204 may transform categorical data into numerical formats that are suitable for machine learning algorithms. In this regard, the data pre-processing engine 204 may use techniques such as one-hot encoding or label encoding depending on the nature of the categorical variables and the intended use of the data.

In some embodiments, the data pre-processing engine 204 may also include dimensionality reduction techniques, where the number of input features is reduced while retaining the most relevant information. In this regard, the data pre-processing engine 204 may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine 204 may then be fed into the model training module 206.

The model training engine 206 may be responsible for training the generative AI models using the pre-processed data from the data pre-processing engine 204. The model training engine 206 may implement various machine learning algorithms, including but not limited to Generative Adversarial Networks (GANs), Variational Autoencoders (VAEs), or other generative models, depending on the specific requirements of the system. The model training engine 206 may optimize these models by continuously adjusting their internal parameters based on the patterns and relationships identified within the data.

In some embodiments, the model training engine 206 may include a training data handler, which manages the partitioning of the pre-processed data into training, validation, and testing datasets. The training data is used to update the model's parameters, while the validation and testing datasets are reserved to evaluate the model's performance during and after training. The model training engine 206 may support various data-handling strategies, such as cross-validation or random shuffling, to ensure that the model generalizes well and is not overfitting to the training data.

For VAEs, the model training engine 206 may implement an encoder-decoder architecture. In this architecture, the encoder is responsible for compressing or mapping the input data into a lower-dimensional latent space representation, capturing the essential features of the input data while discarding unnecessary details. The decoder, in turn, reconstructs the input data from this latent representation, aiming to recreate the original data as closely as possible. During training, the VAE model seeks to minimize a loss function that typically consists of two components: reconstruction loss and Kullback-Leibler (KL) divergence loss.

The reconstruction loss ensures that the difference between the original input and the reconstructed output is minimized, guiding the decoder to generate outputs that closely resemble the input data. The second component, KL divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In embodiments using GANs, the model training engine 206 may train two distinct but interconnected networks: the generator and the classifier. The generator network is responsible for generating synthetic data samples, typically starting from random noise vectors or points sampled from a latent space. The generator's objective is to learn how to map this random input into realistic data that closely resembles the actual data distribution from the training set, such as images, financial plans, or any other domain-specific data. On the other side, the classifier network is tasked with differentiating between the real data—coming directly from the training set—and the synthetic data generated by the generator. The classifier acts as a binary classifier, aiming to correctly classify whether the input data is real or fake. Its job is to improve its accuracy over time in detecting whether the data it is evaluating comes from the true data distribution or has been synthetically created by the generator.

The training process of a GAN is adversarial in nature, where the two networks engage in a zero-sum scenario. The generator continuously tries to improve its ability to generate convincing data, while the classifier simultaneously improves its capacity to distinguish between real and generated data. During each training iteration, the generator attempts to “fool” the classifier by creating more realistic data samples, while the classifier receives feedback to better catch fake data. This adversarial feedback loop leads both networks to improve their performance over time. The loss functions for both networks guide this competition: the generator's loss reflects how well it was able to fool the classifier, while the classifier's loss reflects how accurately it classified real versus generated data. Through this iterative, competitive process, the generator becomes increasingly skilled at producing highly realistic data samples that are difficult for the classifier to differentiate from real data. Eventually, the generator learns to generate synthetic data that is nearly indistinguishable from the real data.

The model training engine 206 may include a parameter optimization module, which may optimize the model's parameters using gradient-based optimization techniques such as stochastic gradient descent (SGD), Adam, or other suitable algorithms. The optimization process may minimize the loss function calculated during each training iteration (or epoch), adjusting the weights and biases of the model to improve its ability to learn from the data. The parameter optimization module may also dynamically adjust learning rates, momentum, and other hyperparameters to further enhance training efficiency.

In some embodiments, the model training engine 206 may implement early stopping mechanisms to prevent overfitting. Early stopping monitors the generative AI model's performance on the validation dataset, halting the training process if the performance does not improve after a specified number of iterations. This ensures that the generative AI model does not continue training on noise or irrelevant patterns, which could degrade its performance on unseen data. The model training engine 206 may also support distributed training across multiple computing nodes, allowing the system to scale its computational resources as needed. Distributed training may involve splitting the generative AI model and data across multiple machines or GPUs, where each node processes a portion of the data and updates the model in parallel. This is particularly useful for large datasets or models that require significant computational power, such as deep generative models. The model training engine 206 may synchronize the updates across the nodes using techniques like synchronous or asynchronous gradient descent.

Once the generative AI model is trained, the model training engine 206 may save the final trained generative AI model in a persistent storage location for future use. In specific embodiments, metadata such as the number of epochs, the final loss values, and values of learned parameters may be logged for model versioning and/or retraining at a later stage. In some embodiments, the model training engine 206 may also implement transfer learning, where a pre-trained model is fine-tuned on a smaller, domain-specific dataset. This may reduce the amount of time and data required to train a new model, especially in cases where the available data is limited or highly specialized. The model training engine 206 may adjust the parameters of the pre-trained model to better align with the new dataset, while preserving the learned features from the original training.

In embodiments where a VAE is used to train the generative AI model, generating new output involves providing an input to the trained model in the form of a point or distribution in the latent space. During training, the encoder network learned to compress input data into this latent space, while the decoder learned to map points from the latent space back into meaningful data. To generate new data, the system may sample a point from the latent space, typically by sampling from a predefined distribution (e.g., a Gaussian distribution), or a user may provide specific coordinates within the latent space to control the nature of the output. The decoder network then transforms this latent vector into a new data instance (e.g., an image or piece of text) that conforms to the patterns learned during training. Since the latent space has been structured to capture the key features of the input data, small variations in the latent space coordinates may result in new data with slight variations, allowing the system to produce diverse but coherent outputs.

In embodiments where the generative AI model has been trained using a GAN, the process for generating new output also involves providing an input in the form of a random noise vector sampled from the latent space. Unlike VAEs, where the latent space is learned explicitly during training, GANs use this latent space as a starting point for the generator to produce new data. The trained generator network takes the random input vector and transforms it into a new data sample, such as an image, based on the patterns it has learned during training. The classifier is no longer needed in this phase, as its role was limited to training. Once the generator has been trained to produce realistic outputs, it can generate new data by mapping random noise vectors to complex data points that resemble the original dataset. For example, in a GAN trained on images of landscapes, providing a random vector in the latent space will result in the generation of a new, never-before-seen landscape that adheres to the patterns the generator learned during training. The latent space in GANs encodes abstract features of the data, and small adjustments to the noise vector allow users to control specific aspects of the generated data, such as color, shape, or texture, enabling the generation of highly varied outputs.

It will be understood that the embodiment of the generative AI subsystem 200 illustrated in FIG. 2 is exemplary and that other embodiments may vary. The generative AI subsystem 200, as well as its constituent elements, may vary, and modifications or alternative configurations may be implemented without departing from the broader scope of the invention. For instance, different machine learning algorithms, data sources, optimization techniques, or training methodologies may be employed depending on system requirements, application domain, and available computational resources. Furthermore, features and functionalities described in one embodiment may be combined with those of another embodiment as needed, and vice versa.

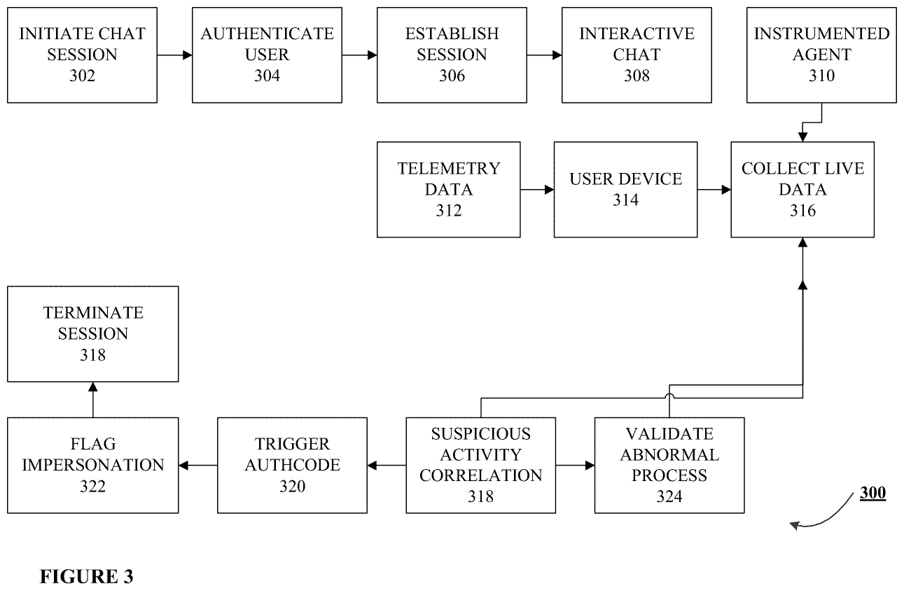

FIG. 3 illustrates a process flow 300 for real-time telemetry-based detection of impersonation in interactive dialogue applications, in accordance with an embodiment of the disclosure. At block 302, the process begins with the initiation of a chat session. A user engages with an interactive dialogue application, such as a chatbot, virtual assistant, or any real-time conversational agent, to begin a live conversation. This step involves the system creating a new session between the user and the application by establishing communication protocols. For example, the system may rely on HyperText Transfer Protocol Secure (HTTPS) to establish a secure connection between the client device and the server hosting the chatbot, ensuring that all transmitted data is encrypted. During session initiation, session-specific data, such as session tokens, may be generated and exchanged to authenticate and manage the user's interaction throughout the chat. These tokens help to ensure that session continuity is maintained while preventing session hijacking, a potential vector for impersonation attacks. In some implementations, WebSocket protocol may be used to facilitate full-duplex communication between the user device and the application, allowing for real-time data exchange necessary for dynamic and continuous user interaction.

At block 304, the system performs user authentication to verify the identity of the user. This authentication process can vary based on the sensitivity of the session or the system's security protocols. For basic interactions, standard username and password combinations may suffice, leveraging protocols such as Secure Hash Algorithm (SHA) to hash the password before transmission, reducing the likelihood of credential malfeasance during transmission. In more secure implementations, the system may utilize multi-factor authentication (MFA), requiring a combination of factors like something the user knows (e.g., a password), something the user has (e.g., a one-time password generated by a time-based token or delivered via SMS), and/or something the user is (e.g., biometric data such as fingerprints or facial recognition). These MFA techniques may be implemented using protocols such as Time-based One-Time Password (TOTP) or the FIDO2 standard, which leverages cryptographic methods to authenticate the user. Once the authentication is complete, a session is formally established at block 306, where the system assigns a unique session ID to the user and stores relevant metadata (e.g., timestamp, device type, location) to maintain state across the conversation. This metadata may be useful for later anomaly detection, especially if discrepancies arise between typical user behavior and the current session.

At block 308, the system facilitates an interactive chat between the user and the chatbot. During this phase, the user provides inputs—such as queries, commands, or requests—and the chatbot responds by processing the input and delivering relevant information or actions. For instance, in an e-commerce setting, the chatbot might assist the user with making a purchase by querying a database for product availability. Communication between the client device and the server during the interactive session is conducted using protocols like JSON (JavaScript Object Notation) over WebSocket or HTTP, ensuring the rapid exchange of data. Each interaction is logged in the server for audit purposes and, importantly, for correlation with telemetry data.

As the chat progresses, the system deploys an instrumented agent at block 310. This instrumented agent is responsible for collecting and monitoring telemetry data in real time from the user's device during the active chat session. The agent may be embedded within the client-side application (e.g., a browser-based chatbot or a mobile app) and operates without interrupting the user experience. The telemetry data includes, but is not limited to, CPU usage, memory consumption, network traffic (both incoming and outgoing), power consumption, and state metrics of the client device. These telemetry parameters are continuously monitored and reported back to the server for analysis. For example, the agent may leverage the Web Performance API in web-based environments to gather real-time performance data, or it may interact with lower-level system APIs on mobile devices (such as Android's BatteryManager or iOS's ProcessInfo APIs) to collect CPU and power consumption data. Additionally, the instrumented agent may utilize network traffic analysis tools (e.g., Deep Packet Inspection, DPI) to assess data transmission behaviors, comparing them against known normal patterns for the user or device.

Telemetry data monitoring can reveal key indicators of impersonation attacks, such as abnormal resource consumption during what should be a lightweight chat session. For example, a drastic spike in CPU usage while interacting with the chatbot may indicate that an unauthorized process is running in the background, such as malware attempting to hijack the session or misappropriate sensitive information. Similarly, an unusual surge in outbound network traffic may signal an exfiltration attempt, where sensitive data is being transmitted to an unknown third party.

The telemetry data collected at block 312 includes various operational metrics from the user device (block 314), such as CPU usage, memory consumption, network traffic, and other resource utilization metrics. This telemetry data is critical for providing real-time insight into the performance and behavior of the client device throughout the chat session. For instance, CPU usage metrics can reveal how much processing power the device is consuming, which, when unusually high, may indicate the presence of hidden or malicious processes running alongside the interactive dialogue application. Memory consumption metrics track how much RAM is being utilized by the system, helping detect resource-hogging processes that may be indicative of unauthorized scripts or botnets attempting to hijack the session. Network traffic metrics monitor the amount and type of data being transmitted to and from the user device. Abnormally high incoming or outgoing traffic during a simple text-based chat interaction may suggest data exfiltration or external control attempts. These metrics can be gathered using various system APIs, such as Linux's top command or Windows Performance Monitor, and can also be collected via real-time APIs, such as getPerformance( ) in JavaScript for web-based applications.

In some embodiments, other metrics such as power consumption, device state, and disk I/O activity may also be collected. For example, power consumption can spike if malware is utilizing hardware resources intensively, while abnormal disk I/O may indicate a hidden process reading or writing large amounts of data to or from the disk. This comprehensive collection of telemetry data allows the system to continuously evaluate the device's performance against expected norms and alert the system when deviations are detected.

At block 316, the instrumented agent collects live telemetry data continuously, ensuring that real-time monitoring is performed without interruption. This uninterrupted collection of data is crucial for detecting anomalies in the early stages of a potential attack. The telemetry monitoring agent operates in the background, continuously sampling metrics such as CPU cycles, memory allocations, and network packet transfers. Various techniques, such as polling or event-driven monitoring, may be used to collect this data. Polling involves periodically checking the state of the system at fixed intervals, while event-driven monitoring can trigger alerts or data collection when certain thresholds or events occur, such as exceeding a predefined CPU usage limit. The collected telemetry data is transmitted in real-time to a central monitoring server for further analysis. Transmission protocols such as Message Queuing Telemetry Transport (MQTT) or WebSocket may be employed to ensure low-latency, continuous communication between the client device and the server. These protocols are lightweight and ideal for environments where data needs to be pushed in real time without overwhelming the network.

The collected telemetry data is then analyzed at block 318 for suspicious activity correlation. The system compares the telemetry data against predefined baselines or historical data sets to identify abnormal patterns that deviate from expected user or device behavior. For instance, if the system detects a sudden surge in CPU usage during a simple chatbot interaction, it may flag this as suspicious, as most interactions are typically lightweight and should not require significant processing power. Historical data may include the device's previous performance metrics during similar chat sessions, which are used as a benchmark for normal operation. In addition, the system may apply machine learning algorithms or heuristic-based detection methods to identify potential correlations between telemetry metrics. For example, if a spike in CPU usage is consistently correlated with an increase in outgoing network traffic during user sessions, the system may deduce that the session is under attack, possibly by a botnet or malware attempting to exfiltrate sensitive information.

In some implementations, anomaly detection models such as K-Means clustering or Gaussian Mixture Models (GMM) may be used to identify outlier data points in the telemetry stream. These models are designed to recognize when current telemetry metrics fall outside of the normal distribution based on historical data, thereby providing an early warning system for impersonation attacks or other suspicious activities.

If a correlation to suspicious activity is identified, the system proceeds to block 320, where it triggers an authorization code (AuthCode) through an Out-of-Band Authentication (OoBA) process. This step adds an additional layer of security to the session. The system sends an authorization code to the user's registered mobile device or email address through a separate communication channel—outside the primary chat session. The OoBA method is commonly used in financial systems to verify the identity of a user without interrupting the primary session. Protocols such as OAuth 2.0 or FIDO2 can be used to manage the generation and validation of the authorization codes. The user must input the code within a specific timeframe to validate their legitimacy and confirm that the session has not been compromised. For example, if the telemetry data indicated suspicious activity like an unexpected increase in network traffic or an unfamiliar IP address, the system would use OoBA to re-authenticate the user, ensuring that the legitimate user is still in control of the session.

At block 322, if the user fails the OoBA or if the telemetry data continues to show abnormal activity, the system will flag the session for impersonation. This step involves the system marking the session and/or device as potentially compromised. Failure to complete the OoBA process—whether due to the user not receiving the code or entering an incorrect code—could indicate that the session has been taken over by an unauthorized user. In such cases, the system restricts the flagged device or user from further interaction, disabling their ability to continue the session. This restriction may also extend to future login attempts, where the system will require additional authentication steps or temporarily block access altogether. The flagged session may trigger logging or audit procedures where telemetry and session data are stored for further investigation by system administrators or security teams.

At block 318, if the suspicious activity persists, the system may proceed to terminate the session. This ensures that any unauthorized access or impersonation attempts are halted immediately. Session termination may involve several processes, including sending a termination signal to the client device and logging the event. The system could also issue session cookies invalidation, ensuring that the compromised session cannot be reused or hijacked further. Network protocols such as Transmission Control Protocol (TCP) may be leveraged to gracefully shut down the session by closing the socket connections between the client and the server. If the threat is severe, the system may also initiate broader defensive measures, such as blocking the flagged IP address or device from future interactions with the server.

Finally, at block 324, the system performs a validation of the abnormal process. This step is critical to ensure that the flagged behavior truly represents malicious or unauthorized activity before further actions, such as blocking the device permanently, are taken. The system re-evaluates the telemetry data and cross-checks it against a wider dataset to verify that the detected anomaly was not a false positive. For example, an unexpected spike in CPU usage may have been caused by a legitimate software update running in the background rather than a malicious process. During this validation phase, digital forensics tools may be used to analyze system logs, execution traces, and memory dumps from the client device. If the validation process confirms that the flagged process was indeed malicious, the system may proceed with more permanent actions, such as device blocking, session data quarantining, or alerting security personnel for further investigation.

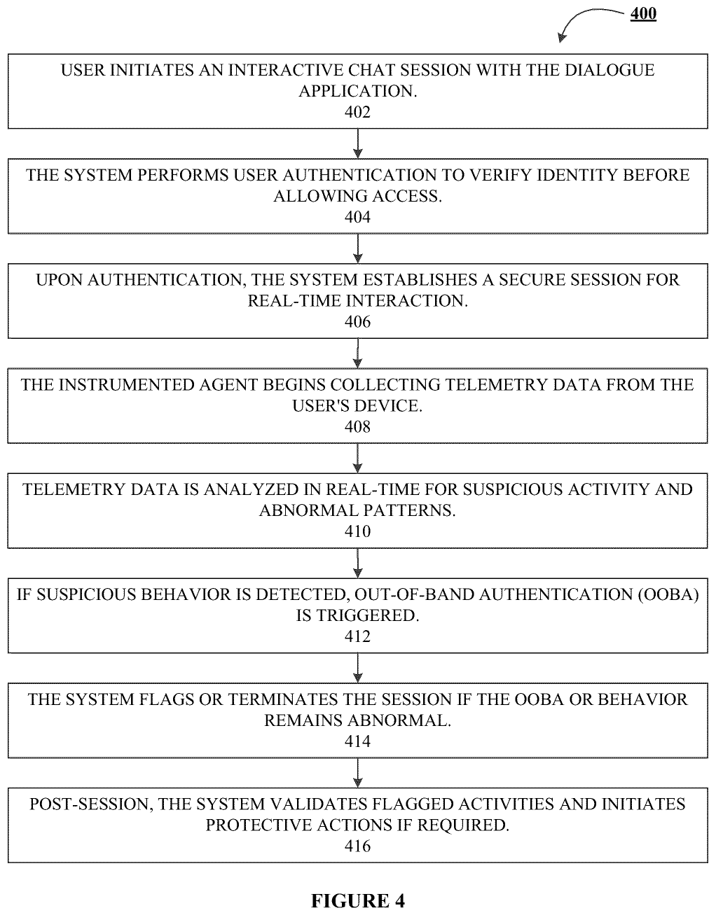

FIG. 4 illustrates a process flow 400 for real-time telemetry-based detection of impersonation in interactive dialogue applications, in accordance with an embodiment of the disclosure. At block 402, the process begins with the user initiating an interactive chat session with the dialogue application. This involves the user connecting to the system via a client device, such as a smartphone, laptop, or desktop, and engaging with the chatbot or virtual assistant. The session initiation typically occurs through a front-end interface, such as a web-based form or a mobile app. The system receives a session initiation request from the client device and allocates server-side resources to handle the session. During this process, a session token may be created to maintain session continuity and track interactions between the user and the dialogue application. The session initiation may occur over secure communication protocols, such as HTTPS, ensuring that the connection between the client and the server is encrypted and resistant to interception or eavesdropping.

At block 404, the system performs user authentication to verify the identity of the user before allowing access. The authentication process is crucial in ensuring that only legitimate users can interact with the dialogue application. The system may use a variety of authentication mechanisms depending on the security requirements of the session. Basic authentication might involve username and password verification, where credentials are hashed using algorithms such as SHA-256 before transmission to the server. For enhanced security, the system may employ multi-factor authentication (MFA), combining knowledge-based authentication (e.g., passwords) with possession-based authentication (e.g., one-time passwords or push notifications). Biometrics, such as fingerprint scans or facial recognition, may also be used, particularly in high-security environments. The system checks these credentials against stored values in a secure database, typically using identity and access management protocols such as OAuth 2.0 or LDAP (Lightweight Directory Access Protocol). Once the user is authenticated, the session proceeds to the next phase.

At block 406, upon successful authentication, the system establishes a secure session for real-time interaction. This step formalizes the connection between the user and the chatbot by assigning a session ID and configuring the session parameters. The session ID is a unique identifier that allows the system to maintain state across multiple user interactions during the session. This is particularly important in a stateless protocol like HTTP, where each request is independent of previous ones. In this step, session-level security features such as Secure Socket Layer (SSL) or Transport Layer Security (TLS) encryption may be enforced to ensure that all communications are secure. The system may also set session timeouts or limits, ensuring that the session is automatically terminated after a period of inactivity to prevent unauthorized use.

At block 408, the instrumented agent begins collecting telemetry data from the user's device. The instrumented agent, typically embedded within the dialogue application or deployed as a separate process on the client device, continuously monitors the system-level metrics of the device during the interactive session. This includes collecting telemetry data such as CPU usage, memory consumption, network activity, disk I/O, and power consumption. These metrics are crucial for assessing the real-time performance of the device and identifying any abnormal behavior that could indicate security issues, such as an impersonation attempt or malware running in the background. The telemetry data is captured using APIs available on the operating system (e.g., Windows Performance Monitor, Android BatteryStats) or through custom-built monitoring tools. This data is sent to the server for further analysis in real-time.

At block 410, the telemetry data is analyzed in real-time for suspicious activity and abnormal patterns. The system continuously compares the incoming telemetry data against a baseline of normal activity patterns. This baseline may be derived from historical data of the same user or generalized across multiple users interacting with the same dialogue application. Anomaly detection algorithms, such as statistical models, machine learning models, or heuristic rules, are employed to identify deviations from expected behavior. For example, if the CPU usage suddenly spikes during a simple text-based chat, or if there is an unexpected surge in network traffic, these might indicate unauthorized processes running on the client device. The system can apply techniques such as Principal Component Analysis (PCA) or clustering algorithms like K-Means to differentiate between normal fluctuations and true outliers that signal suspicious behavior.

At block 412, if suspicious behavior is detected, Out-of-Band Authentication (OoBA) is triggered. In response to abnormal telemetry data, the system initiates an additional security measure by requesting the user to verify their identity through a separate communication channel. OoBA typically involves sending a one-time authentication code (AuthCode) to the user's registered mobile device or email, outside of the primary session's communication channel. This method ensures that even if the session has been compromised by an attacker, the attacker cannot gain access to the secondary communication channel. The user must input the correct AuthCode to validate their session and continue interacting with the chatbot. Common OoBA mechanisms include SMS-based passcodes, email verification links, or push notifications using authentication apps (e.g., Google Authenticator or Microsoft Authenticator).

At block 414, the system flags or terminates the session if the OoBA fails or if the telemetry data continues to show abnormal activity. If the user fails to complete the OoBA process or if further telemetry analysis reveals ongoing suspicious activity, the system flags the session as compromised. Depending on the system's security policies, it may either restrict further actions in the session or terminate it entirely. A flagged session indicates that the system has identified a potential impersonation attempt, and additional security actions may be taken. This could include logging the suspicious activity, notifying security personnel, and blocking the user or device from accessing the system in future attempts. If the session is terminated, all active processes related to the chat session on both the server and the client-side are halted to ensure that no further unauthorized activity can occur.

At block 416, post-session, the system validates flagged activities and initiates protective actions if required. After the session is flagged or terminated, the system performs a final validation of the telemetry data and the detected anomalies to confirm that the flagged behavior is indeed indicative of malicious activity. This validation process may involve correlating the telemetry data with historical records, reviewing the session logs, and cross-referencing the flagged activities with known attack signatures or patterns. If the validation confirms unauthorized access, the system may take protective actions such as blocking the device, notifying the system administrator, or initiating a broader security audit. In cases where the flagged activity was determined to be a false positive, the system can adjust its telemetry analysis algorithms to reduce the likelihood of similar errors in the future.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for real-time telemetry-based detection of impersonation in interactive dialogue applications, the system comprising:
a processing device;
a non-transitory storage device containing instructions when executed by the processing device, causes the processing device to perform the steps of:
initiating an interactive chat session between a user and an interactive dialogue application;
authenticating the user via one or more authentication methods, including at least username and password verification, multi-factor authentication (MFA), or biometric verification;
establishing a real-time session with the interactive dialogue application upon successful authentication of the user;
collecting telemetry data from a user device during the real-time session, wherein the telemetry data includes at least CPU usage, memory consumption, network activity, power consumption, and disk I/O data;
analyzing the collected telemetry data in real-time by comparing the telemetry data against a predetermined baseline or historical patterns of normal user activity, wherein a telemetry analysis is configured to identify abnormal behavior indicative of impersonation or unauthorized access;
triggering an out-of-band authentication (OoBA) process when the telemetry analysis identifies suspicious behavior, wherein the OoBA process includes sending an authorization code to a separate device or communication channel associated with the user;
receiving and validating the authorization code provided by the user in response to the OoBA request;
terminating the interactive chat session if the authorization code is not received or fails validation, or if the telemetry data continues to indicate abnormal activity after the OoBA process; and
flagging the session and associated device for impersonation if unauthorized access is detected, and preventing future access requests from the associated device.

2. The system of claim 1, wherein executing the instructions further causes the processing device to: generate a session token upon initiating the interactive chat session, wherein the session token is used to maintain session continuity and track user interactions throughout the session.

3. The system of claim 1, wherein the telemetry data includes at least one of: disk I/O operations, fan speed, or device battery levels, providing additional metrics for assessing abnormal device behavior during the interactive session.

4. The system of claim 1, wherein analyzing the telemetry data further comprises applying machine learning algorithms to detect suspicious activity by identifying deviations from historical user behavior, wherein the machine learning models are trained to differentiate between normal fluctuations and impersonation attempts.

5. The system of claim 1, wherein the OoBA process includes using a time-based one-time password (TOTP) generated by an authentication app or hardware token associated with the user's account.

6. The system of claim 1, wherein terminating the session further comprises invalidating session cookies and terminating associated API connections to ensure that no further unauthorized activity can occur within a compromised session.

7. The system of claim 1, wherein flagging the session and associated device for impersonation further comprises: storing the telemetry data and session logs in a security database for further forensic analysis and initiating alerts to system administrators for review of flagged activity.

8. A computer program product for real-time telemetry-based detection of impersonation in interactive dialogue applications, the computer program product comprising a non-transitory computer-readable medium comprising code causing an apparatus to perform the steps of:
initiating an interactive chat session between a user and an interactive dialogue application;
authenticating the user via one or more authentication methods, including at least username and password verification, multi-factor authentication (MFA), or biometric verification;
establishing a real-time session with the interactive dialogue application upon successful authentication of the user;
collecting telemetry data from a user device during the real-time session, wherein the telemetry data includes at least CPU usage, memory consumption, network activity, power consumption, and disk I/O data;
analyzing the collected telemetry data in real-time by comparing the telemetry data against a predetermined baseline or historical patterns of normal user activity, wherein a telemetry analysis is configured to identify abnormal behavior indicative of impersonation or unauthorized access;
triggering an out-of-band authentication (OoBA) process when the telemetry analysis identifies suspicious behavior, wherein the OoBA process includes sending an authorization code to a separate device or communication channel associated with the user;
receiving and validating the authorization code provided by the user in response to the OoBA request;
terminating the interactive chat session if the authorization code is not received or fails validation, or if the telemetry data continues to indicate abnormal activity after the OoBA process; and
flagging the session and associated device for impersonation if unauthorized access is detected, and preventing future access requests from the associated device.

9. The computer program product of claim 8, wherein the code further causes the apparatus to perform the steps of: generate a session token upon initiating the interactive chat session, wherein the session token is used to maintain session continuity and track user interactions throughout the session.

10. The computer program product of claim 8, wherein the telemetry data includes at least one of: disk I/O operations, fan speed, or device battery levels, providing additional metrics for assessing abnormal device behavior during the interactive session.

11. The computer program product of claim 8, wherein analyzing the telemetry data further comprises applying machine learning algorithms to detect suspicious activity by identifying deviations from historical user behavior, wherein the machine learning models are trained to differentiate between normal fluctuations and impersonation attempts.

12. The computer program product of claim 8, wherein the OoBA process includes using a time-based one-time password (TOTP) generated by an authentication app or hardware token associated with the user's account.

13. The computer program product of claim 8, wherein terminating the session further comprises invalidating session cookies and terminating associated API connections to ensure that no further unauthorized activity can occur within a compromised session.

14. The computer program product of claim 8, wherein flagging the session and associated device for impersonation further comprises: storing the telemetry data and session logs in a security database for further forensic analysis and initiating alerts to system administrators for review of flagged activity.

15. A method for real-time telemetry-based detection of impersonation in interactive dialogue applications, the method comprising:
initiating an interactive chat session between a user and an interactive dialogue application;
authenticating the user via one or more authentication methods, including at least username and password verification, multi-factor authentication (MFA), or biometric verification;
establishing a real-time session with the interactive dialogue application upon successful authentication of the user;
collecting telemetry data from a user device during the real-time session, wherein the telemetry data includes at least CPU usage, memory consumption, network activity, power consumption, and disk I/O data;
analyzing the collected telemetry data in real-time by comparing the telemetry data against a predetermined baseline or historical patterns of normal user activity, wherein a telemetry analysis is configured to identify abnormal behavior indicative of impersonation or unauthorized access;
triggering an out-of-band authentication (OoBA) process when the telemetry analysis identifies suspicious behavior, wherein the OoBA process includes sending an authorization code to a separate device or communication channel associated with the user;
receiving and validating the authorization code provided by the user in response to the OoBA request;
terminating the interactive chat session if the authorization code is not received or fails validation, or if the telemetry data continues to indicate abnormal activity after the OoBA process; and
flagging the session and associated device for impersonation if unauthorized access is detected, and preventing future access requests from the associated device.

16. The method of claim 15, wherein the method further comprises: generate a session token upon initiating the interactive chat session, wherein the session token is used to maintain session continuity and track user interactions throughout the session.

17. The method of claim 15, wherein the telemetry data includes at least one of: disk I/O operations, fan speed, or device battery levels, providing additional metrics for assessing abnormal device behavior during the interactive session.

18. The method of claim 15, wherein analyzing the telemetry data further comprises applying machine learning algorithms to detect suspicious activity by identifying deviations from historical user behavior, wherein the machine learning models are trained to differentiate between normal fluctuations and impersonation attempts.

19. The method of claim 15, wherein the OoBA process includes using a time-based one-time password (TOTP) generated by an authentication app or hardware token associated with the user's account.

20. The method of claim 15, wherein terminating the session further comprises invalidating session cookies and terminating associated API connections to ensure that no further unauthorized activity can occur within a compromised session.
